(19) United States
(12) Patent Application Publication
(10) Pub. No.: US 2012/0088555 A1
(43) Pub. Date: Apr. 12, 2012

(54) WIRELESS CHARGING EQUIPMENT FOR MOBILE PHONES

(76) Inventor: Jianzhong HU, Shenzhen (CN)

(21) Appl. No.: 12/903,196

(22) Filed: Oct. 12, 2010

(51) Int. Cl. H04B 1/38

(52) U.S. Cl. 455/573

(57) ABSTRACT

The present invention provides a wireless charging equipment for mobile phones for mobile phones. The charging equipment comprises a protection cover with a switch port and a charger with an internal battery arranging therein. The mobile phone is enveloped in the protection cover, one end of the switch port is electrically connected with the socket of the mobile phones while the other end is electrically connected with the charger which is detachable from the switch port, the mobile phone then could be charged via the electricity provided by the internal battery. The charging equipment is facilitated to carry, when travelling to some places where it is not easy to find somewhere to charge, people can charge the mobile phone by using the internal battery of the present invention so as to extent the working time of the mobile phone. When charging is not processing, the protection cover of the present invention can serve as a common mobile phone protection cover, avoiding the mobile phone from scratching or crashing. Moreover, contact points are positioned on the protection cover and the charger of the present invention, The contact points can be designed in a consistent pattern, enabling different mobile phones to charge by using the same charger and protection cover, thereby it can be universally used.

### FIELD OF THE INVENTION

The present invention relates to a wireless charging equipment for mobile phones, and more particularly to a portable wireless charging equipment for mobile phones which having an internal battery arranged therein.

### BACKGROUND OF THE INVENTION

As the development of the society, portable electronic products such as mobile phones, MP3, PDA etc. are becoming widely used, However, these electronic products only can work under continuous electricity supply. For such kind of mobile phones, the capacities of their internal batteries is very, limited owing to the small volume, therefore, it is necessary to charge the batteries regularly when it is out of electricity. However, when under some circumstances, such as travelling on a coach or on a train, or even in some outlying areas, charging sockets are not facilitated to be found. In this case, these mobile phones will become useless if additional electricity could not be provided when electricity thereof is exhausted. Therefore, a portable electricity supply equipment which can extend the working time of these mobile phones by supplying electricity when under the above-mentioned situations is needed.

Currently, The mobile phones available are all charged by adopting wired charging equipment connecting with the external electric kind of products are usually corresponding charging equipment, consequently, when the equipment is power off or could not match the mobile phone, impossible to charge the mobile phone.

It is therefore desirable to provide a wireless charging equipment which can be employed universally and to solve the above-mentioned problems.

### SUMMARY OF THE INVENTION

A main feature of the present invention is to provide a wireless charging equipment which can be employed universally.

To achieve the above-mentioned feature, the present invention provides a wireless charging equipment for mobile phones which a spare battery is arranged therein. The charging equipment comprises a protection cover with a switch port and a charger with an internal battery, when the mobile phone is enveloped in the protection cover, one end of the switch port could be electrically connected with the mobile phones while the other end also could be electrically connecting with the charger, the mobile phone then could be charged via the electricity from the internal battery.

As one preferred embodiment of the present invention, the charger comprises contact points with one end is electrically connected with the internal battery and the other end is electrically connected with the switch port of the protection cover accordingly, therefore, the mobile phone could be charged from the internal battery through the charger contact points and the switch port of the protection cover electrically connecting together.

As a preferred embodiment of the present invention, the charger comprises at least one couple of charger contact points for connecting the internal battery and the switch port of the protection cover, the present charger could be accordingly electrically connected with at least one mobile phone which are enveloped in the protection cover, enabling several mobile phones to charge simultaneously via one charger.

As another preferred embodiment of the present invention, the charger further comprises an external electric supply interface, which is adopted to connect with the internal battery or the mobile phone so as to transfer to external electricity into it. The external electric supply interfaces could comprises an AC interface and a USB interface, using for connecting with the external AC and USB electricity supply. Thus, when connecting with the external electric supply, charging to the internal battery of the charger and the mobile phone can be simultaneous or optional.

As another preferred embodiment of the present invention, the protection cover also comprises contact points which are located on the rear side or the lateral side thereof, one end of the contact point hereof could be electrically connected with the switch port while the other end could be electrically connected with the charger contact point, therefore, the mobile phone could be charged from the internal battery through the contact points and the protection cover contact points electrically connecting together. Moreover, the protection cover could further be divided into a upper cover and a lower cover. One side of the mobile phone which having the charging socket arranged therein is enveloped in the lower cover and the switch port is arranged on the cross-sectional side, extending to the inside of the protection cover. The contact points are positioned on the rear side of the lower cover. The upper cover envelops the other side of the mobile phone so as efficiently protect it. Therefore, the protection cover can transfer the electricity of the internal battery to the battery of the mobile phone via the electrical connection between the contact points of the protection cover and the charger, achieving a “point to point” charging mode, it is superior to the current wired charging mode and also can protect the mobile phone when charging.

The protection cover also comprises a plurality of holes which is employed for allowing the wires to get through and preventing the camera of the mobile phone from covering by the protection cover.

The charger is provided with a charging circuit in which a MCU management module, a battery capacity monitoring module, a charging circuit protection module, a charging voltage monitoring module, a charging current monitor module and a voltage booster module are arranged and the MCU management module is electrically connected with the other modules; All the modules are electrically connected with the contact points of the charger and the internal battery; The battery capacity monitoring module is employed to detect the quantity of electricity of the internal battery; The charging circuit protection module is used to protect the charging circuit from damaging when the current or the voltage is over high; The charging voltage monitoring module is employed to detect the voltage of the mobile phone, whereby to decide whether to boost the voltage or not; The charging current monitor module is employed to detect the current for the mobile phone, whereby to decide whether charging is finished, The voltage boost module is adopt to boost the voltage of the internal battery to the level of the required voltage of the mobile phone; The MCU is employed to control and manage the above-mentioned modules.

Comparing with the prior art, the wireless charging equipment for mobile phones of the present invention possesses remarkable advantages as follow:

Firstly, the charging equipment of the present characteristic of portable and small. When travelling to some places where it is not facilitated charging battery, the present invention can charge the mobile phone by its internal battery, thereby to extent the working time of the mobile phone.

Secondly, When charging is not processing, the protection cover of the present invention can serve as a common mobile phone protection cover, avoiding the mobile phone from scratching or crashing.

Thirdly, contact points are positioned on the protection cover and the charger of the present invention, whereby electricity charger can be transferred into the mobile phone. The contact points can be designed in a consistent pattern, enabling different mobile phones to charge by using, the same charger and protection cover.

Fourthly, electricity can be transferred via the contact points of the charger and the protection cover, it replaces the current wired equipment and greatly simplifies the charging equipment. Meanwhile, Internal battery which is arranged in the charger is employed to take place of the external electricity supply, facilitating people to charge in anywhere.

Finally, the present invention can be widely used, it adapted to various mobile phones, such as mobile phones, PDA, etc. which are portable.

### BRIEF DESCRIPTION OF THE DRAWINGS

These and other objects of the present invention can be better appreciated from the following detailed description of the preferred embodiments and the accompanying drawings, in which:

FIG. 1 shows a front view of a protection cover according to the embodiments of the present invention;

FIG. 2 shows a rear view of the protection cover according to the embodiments of the present invention;

FIG. 3 shows a front view of a charger according to the embodiments of the present invention;

FIG. 4 shows a exploded view when the mobile phone is enveloped in the protection cover according to the embodiments of the present invention;

FIG. 5 shows a exploded view of the front side of the protection cover according to the embodiments of the present invention;

FIG. 6 shows a exploded view of the rear side of the protection cover according to the embodiments of the present invention;

FIG. 7 is a connection diagram illustrating the charging procedure from the external electricity supply to the internal battery;

FIG. 8 is a connection diagram illustrating the charging procedure from the internal battery to the mobile phone;

FIG. 9 is a connection diagram illustrating the connection of the charging units without the protection cover contact point.

FIG. 10 is a connection diagram illustrating the connection of the charging units with the protection cover contact point;

FIG. 11 is connection diagram illustrating the charging circuit of the present invention.

### DETAILED DESCRIPTION OF THE INVENTION

Various preferred embodiments of the invention will now be described with reference to the figures, wherein like reference numerals designate similar parts throughout the various views.

Referring to FIG. 1-3, the wireless charging equipment for mobile phones of the present invention comprises a protection cover 2 with a switch port 21 and a charger 1 with an internal battery 11 arranged therein. The protection cover 2 envelops the mobile phone with one end of the switch port 21 is electrically connected with the mobile phones while the other end is electrically connected with the charged which is detachable from the switch port. The mobile phone will be charged via the electricity provided by the internal battery 11.

Referring to FIG. 4, when charging is not processing, the protection cover 2 can serve as a common protection cover enveloping the mobile phone 3, avoiding the mobile phone 3 from scratching or crashing; When charging is needed, put the mobile phone 3 which is enveloped in the protection cover 2 on the charger 1 so as to enable the switch port of the protection cover 2 connecting with the internal battery of the charger electrically, thereby charging is processing. It is very convenient and simple to operate.

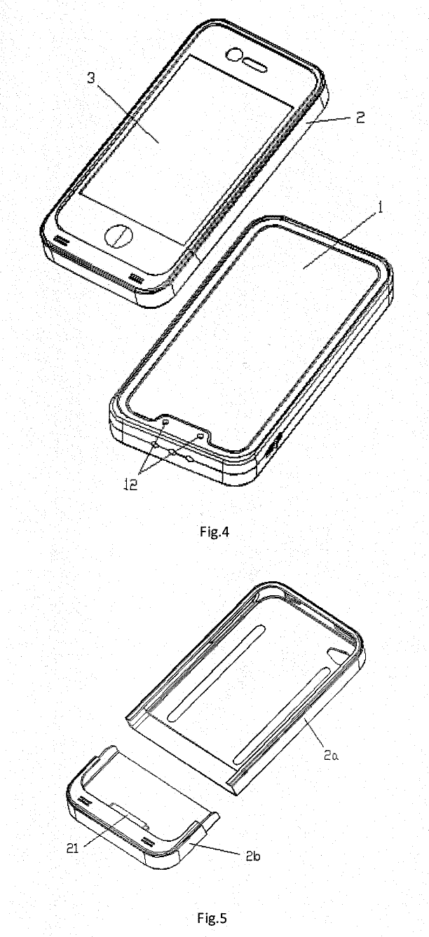

Referring to FIG. 3, the charger 1 comprises charger contact points 12, one end of the contact point 12 is electrically connected with the internal battery 11 and the other end is electrically connected with the switch port 21 of the protection cover 2 accordingly; Therefore, the electricity provided by the internal battery 11 is transferred to the mobile phone via the charger contact points 12 and the switch port 21. The charger contact points 12 can be designed in a consistent pattern and used in conjunction with the protection cover 2 and the switch port 21, which enables different mobile phones to charge by using the same charger and protection cover. Such kind of design can be universally used. The charger comprises at least one couple of contact points. When the charger contact points 12 are more than one couple, they could simultaneously connect with several mobile phones which are enveloped in the protection covers 2 via electricity when charging.

The charger 1 further comprises an external electric supply interface 13, which is adopted to transfer the external electricity into the mobile phone. The external interfaces 13 could comprises an AC interface 131 and a USB interface 132, using for connecting with the external AC and USB power supply.

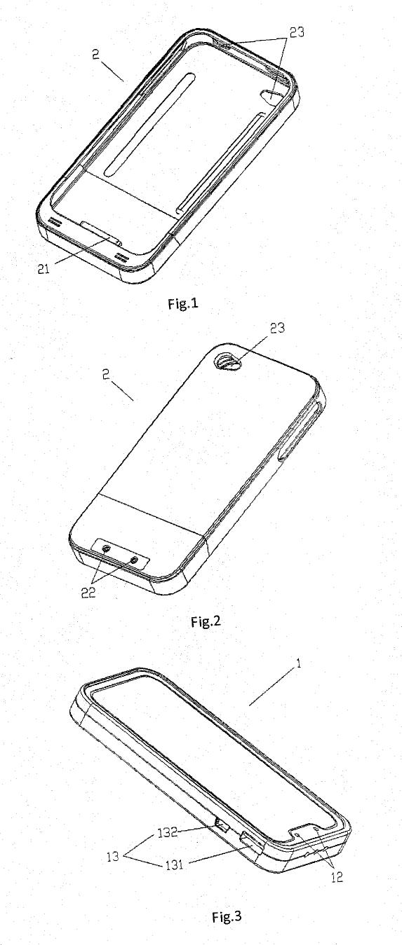

Referring to FIG. 2, FIG. 5 and FIG. 7, the protection cover 2 also comprises contact points 12 which are located on the rear side or the lateral side thereof. One end of the contact point 22 connected with the switch port 21 while the other end connected with the charger contact point 12 when charging is processing. The mobile phone could be put on the charger 1 to charge the battery via the connection of the protection cover contact points 12 and the charger contact points 12.

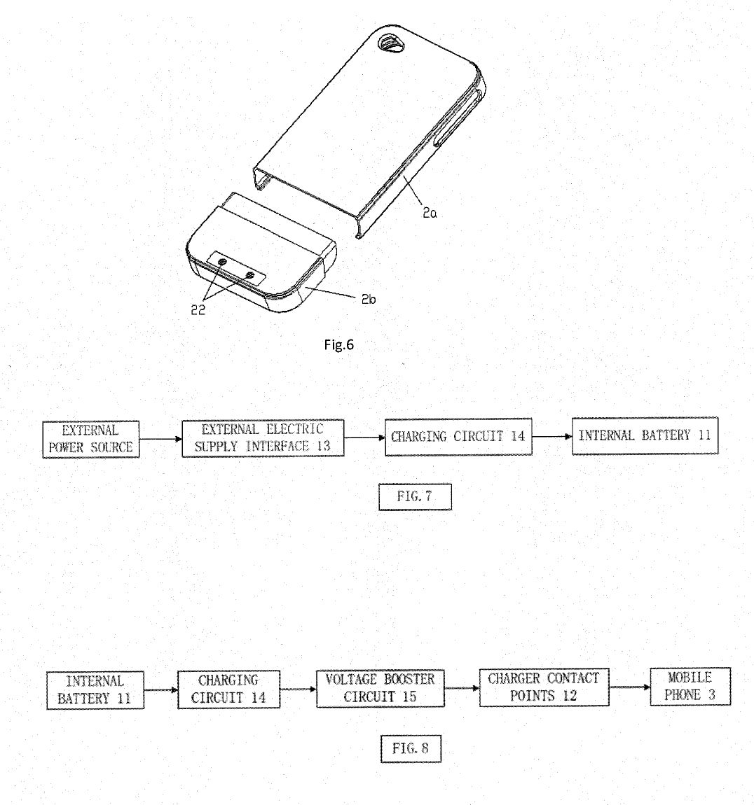

Referring to FIG. 5 and FIG. 6, the protection cover could further be divided into an upper cover 2a and a lower cover 2b, protection cover 2 can easily envelop the mobile phone. The side of the which having the charging socket arranged therein is enveloped in the lower cover 2b. The switch port 21 is arranged on the cross-sectional side with extending to the inside of protection cover 2 from the lower cover 2b so that it can insert into the charging socket appropriately. The protection cover contact points 22 are positioned on the rear side of the lower cover 2b, when putting the mobile phone on the charger 1, the protection cover contact point 22 connects with the charger contact point 12, resulting in charging. The upper cover 2a envelops the other side of the mobile phone so as to efficiently protect it. Understandly, the switch port 21 also can be portioned on the upper cover 2a.

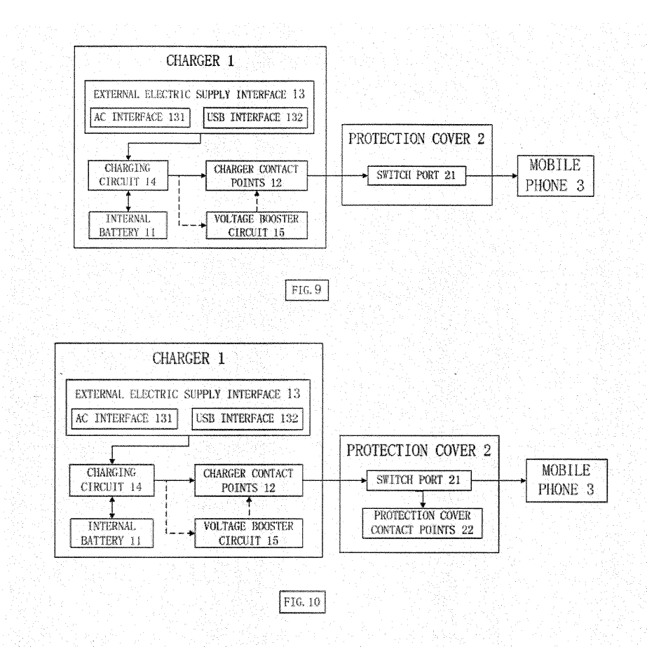

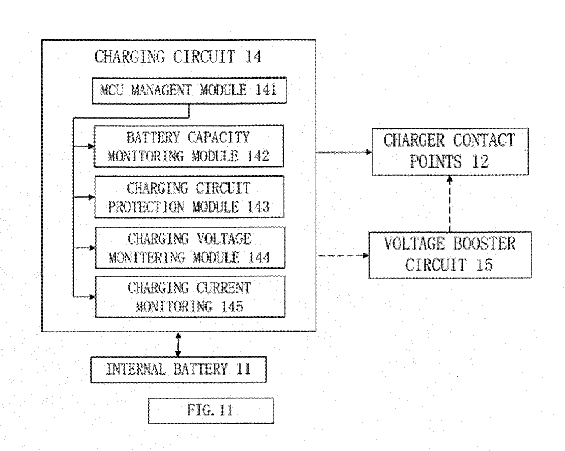

Referring to FIG. 7-10, The charger 1 is provided with charging circuit 14 which is electrically connected with the internal battery 11, the external electric supply socket 13 and the contact points of the charger 12. The charging circuit serves with 3 functions as follows: Firstly, referring to FIG. 7, the charger 1 can connect with the external power supply, when the charger is not connecting with the mobile phone, the internal battery 11 can be charged by the electricity provided by the external power supply via the charging circuit 14. Secondly, referring to FIG. 8, When the charger 1 is not connected with the external power supply but connecting with the mobile phone, the internal battery 11 could charge the mobile phone via the charging circuit 14; Finally, referring to FIG. 9, When the charger 1 is connected with both the external power supply and the mobile phone simultaneously, the external power supply could charge the internal battery 11 and the mobile phone at the same time; When the charging of either the supplying battery 11 or the mobile phone is finished, the charging circuit 14 will keep on charging the other one until both of the internal battery 11 and the mobile phone are fully charged.

Referring to FIG. 10, a MCU management module 141, a battery capacity monitoring module 142, a charging circuit protection module 143, a charging voltage monitoring module 144 and a charging current monitor module 145 are arranging in the charging circuit 14, and the MCU management module 141 is electrically connected with the other modules. All the modules are electrically connected with the contact points of the charger 12 and the internal battery 11. The battery capacity monitoring module 142 is employed to detect the quantity of electricity of the internal battery 11, When the quantity of electricity of the internal battery 11 is small, the internal battery 11 will stop charging the mobile phone, avoiding to damage the internal battery 11 for the insufficient electricity. When the quantity of electricity of the battery is huge, the external power supply will stop charging to prevent the internal battery 11 from damaging for overmuch charging; The charging circuit protection module 143 is used to protect the charging circuit from damaging when the current and the voltage is over high, for example, excessive current caused by short circuit and over high voltage caused by the required high voltage of the mobile phone when charging via the external electric supply; Furthermore, the charging voltage monitoring module 144 is employed to detect the voltage of the mobile phone, whereby to decide whether to boost the voltage or not, therefore, the output voltage of the charged could be adapted to the mobile phone; The charging current monitor module 145 is employed to detect the current for the mobile phone, whereby to decide whether charging is finished, when the current is high, it indicates charging is processing, when the current reduces to a fixed number, charging is finished. The MCU management module is a micro controller unit, employing to control and manage the other four modules, for example, when the charger 1 is connected with the external supply but not with the mobile phone, the MCU management module 141 controls the charging equipment to work in the mode shown in FIG. 7.

Referring to FIG. 8-10, the charger 1 is also provided with a voltage boost circuit 15 which is adopt to boost the voltage of the internal battery 11 to the level of the mobile phone. Under normal circumstances, it is a requirement that the voltage of the charging supply should be higher than the required voltage of the mobile phone when charging, whereby the electricity provided by the charging supply could be transferred into the mobile phone. Therefore, when adopting the internal battery 11 to charge the mobile phone, it is necessary to boost the voltage of the internal battery 11 if the charging voltage monitoring module 144 showing that the required voltage of the mobile phone is equal to or higher than the output voltage of the internal battery 11, thereby electricity could be charged into the mobile phone.

When charging is needed, putting the mobile phone into the protection cover 2 which having a switch port arranging therein, then put the mobile phone on the charger 1, making the contact points of the protection cover 22 connect with the contact points of the charger 12 respectively, furthermore, turn on the switcher of the charger, detecting the voltage according to the charging voltage monitoring module 144. If the required voltage of the mobile phone is higher than the voltage of the internal battery 11, the MCU management module 141 would control the booster circuit to boost the voltage of the internal battery to the required level. During the procedure of charging, the battery capacity monitoring module 142 is responsible of detecting the current value of the supplying value 11 and the charging current monitor module is responsible of detecting the current value of the mobile phone when charging. When the current value is heavy, it indicates that charging is processing, however, when the current reduces to a fixed number, charging is finished. Finally, remove the mobile phone from the charger 1 after it is full charged.

In another preferred embodiment of the present invention, the internal battery can be avoided from the wireless charging equipment. In the present embodiment, the mobile phone should be charging from the external electricity directly.

What is claimed is:

1. A wireless charging equipment for mobile phones, wherein the charging equipment comprises a protection cover with a switch port and a charger with an internal battery, when the mobile phone is enveloped in the protection cover, one end of the switch port could be electrically connected with the mobile phones while the other end also could be electrically connecting with the charger, the mobile phone then could be charged via the electricity from the internal battery.

2. A wireless charging equipment for mobile phones as claimed in claim 1, wherein the charger comprises charger contact points with one end is electrically connected with the internal battery and the other end is electrically connected with the switch port of the protection cover accordingly, therefore, the mobile phone could be charged from the internal battery through the charger contact points and the switch port of the protection cover electrically connecting together.

3. A wireless charging equipment for mobile phones as claimed in claim 2, wherein the charger comprises at least one couple of charger contact points for connecting the internal battery and the switch port of the protection cover, the present charger could be accordingly electrically connected with at least one mobile phone which are enveloped in the protection cover.

4. A wireless charging equipment for mobile phones as claimed in claim 1, wherein the protection cover also comprises contact points which are located on the rear side or the lateral side thereof, one end of the contact point hereof could be electrically connected with the switch port while the other end could be electrically connected with the charger contact point therefore, the mobile phone could be charged from the internal battery through the charger contact points and the protection cover contact points electrically connecting together.

5. A wireless charging equipment for mobile phones as claimed in claim 4, wherein the protection cover could further be divided into a upper cover and a lower cover covering the side of the mobile phone which having the charging socket arranged, the switch port is extending to the inside of the protection cover, the upper cover envelops the other side of the mobile phone so as to efficiently protect it.

6. A wireless charging equipment for mobile phones as claimed in claim 4, wherein the protection cover contact points of the protection cover is arranged on the cross-sectional side of the upper cover.

7. A wireless charging equipment for mobile phones as claimed in claim 1, wherein the charger further comprises an external electric supply interface, which is adopted to transfer the external electricity to the internal battery or the mobile phone.

8. A wireless charging equipment for mobile phones as claimed in claim 7, wherein the external electric supply interfaces comprises an AC interface or a USB interface.

9. A wireless charging equipment for mobile phone as claimed in claim 8, wherein the charger is provided with a charging circuit which is electrically connected with the internal battery, the external electric supply interface and the charger contact point.

10. A wireless charging equipment for mobile phones as claimed in claim 9, wherein the charging circuit comprises:
a battery capacity monitoring module, using for examining the quantity of electricity of the internal battery;
a charging circuit protection module, using for protecting the charging circuit when the current or the voltage is over high;
a charging voltage monitoring module, using for examining the voltage of the mobile phone, whereby to decide whether to boost the voltage or not;
a charging current monitor module, using for examining the current for the mobile phone, whereby to decide whether charging is finished;
a voltage booster module, using for adopting to boost the voltage of the internal battery to the level of the required voltage of the mobile phone;
a MCU management module, using for controlling and managing the above-mentioned modules; and
all the modules are electrically connected with the charger contact points and the internal battery.

11. A wireless charging equipment for mobile phones as claimed in claim 1, wherein the protection cover also comprises a plurality of holes which is employed for allowing the wires to get through, and preventing the camera of the mobile phone from covering by the protection cover.
